(19) United States
(12) Patent Application Publication
(10) Pub. No.: US 2002/0183663 A1
(43) Pub. Date: Dec. 5, 2002

(54) Obliquely erected muscle exercise walker

(76) Inventors: Shun-Tsung Lu, Taichung (TW); Ta-Wei Lu, Brea, CA (US)

Correspondence Address: Raymond Y. Chan, Suite 128, 108 N. Ynez Avenue, Monterey Park, CA, 91754, US

(21) Appl. No.: 10/147,403

(22) Filed: May 17, 2002

Related U.S. Application Data
(63) Continuation-in-part of application No. 10/099,521, filed on Mar. 15, 2002.
Application No. 10/099,521 is a continuation-in-part of application No. 09/873,149, filed on Jun. 4, 2001.

(51) Int. Cl. A61H 1/00

(52) U.S. Cl. 601/28; 601/29; 601/31

(57) ABSTRACT

A walker on which the player has to stand with toes higher than the heels to enjoy a massage at least comprises a base frame having a retainer and a stop at the rear; a pedal over the base frame, having one end linked with the retainer of the base frame, and a free end. The top of the pedal is mounted with a massage pad; and a drive mechanism designed with a bias wheel and linked with the free end of the pedal to make continuous up and down movement.

### CROSS REFERENCE OF RELATED APPLICATIONS

This is a Continuation-In-Part application of a previous non-provisional application, application Ser. No. 10/099,521, filed on Mar. 15, 2002, which is a Continuation-In-Part application of a non-provisional application, application Ser. No. 09/873,149, filed Jun. 4, 2001.

### BACKGROUND OF THE INVENTION

1. Field of the Invention

The invention relates to a body building apparatus, In particular pertaining to an obliquely erected muscle exercise walker on which the player has to stand with toes higher than the heel.

2. Description of the Prior Art

People of the modern age live a busy life, thus many of them, especially the white collar workers doing sedentary work, such as office workers, computer operators, pilots and drivers, are troubled by unnamed illnesses of civilization. The illnesses occur in the muscle and their derivatives are extremely painful. These pains are caused by strain. improper sitting postures or surgical operation. However, such pains can be cured easily by muscular practice and stimulation of blood circulation. But unfortunately, the adequate exercise is what the contemporary lacks, Therefore, designing a body building apparatus to rejuvenate the muscle and blood circulation with least space occupation is an important objective the industry has to strive for.

The bodybuilding and gymnastic apparatus available in the market are bulky and heavy, suitable only for indoor use, not good for those players whose time and space are limited. This is the reason why these kinds of apparatus are hardly popular among people who take exercise to improve their health. In addition, most gymnastic apparatus is designed to work on the development of a certain portion of the muscles without the function of muscular rejuvenation and fatigue alleviation, so it hardly meets the needs of most people.

The inventor has studied the constructional defects the prior art of the obliquely erected muscle exerciser walker for years and has worked hard on the improvement and come up with a novel improvement of the obliquely erected muscle exercise walker as described below.

### SUMMARY OF THE INVENTION

The main object of the invention is to provide an improved obliquely erected muscle exercise walker on which the player has to stand on the pedal with the toes higher than the heels and the body has to incline forward. In order to keep balance, both legs have to stretch out and the spine has to straighten up, and by adjusting slant contact of soles, it applies vitalization and remedial effect on the internal organs such as kidneys, pelvis and backbone.

Another object of the invention is to provide an improved obliquely erected muscle exercise walker with the features of a simplified structure, light weight, easy portability and storage, suitable for office workers, computer operators, pilots, drivers, travelers and survivors from surgical operations to play in houses, cars, cabins and outdoors for a physical exercise without space and time limit, and it is also good for the sportsman to take a warm-up prior to the intense practice.

A walker on which the player has to stand with toes higher than the heels to enjoy a massage at least comprises a base frame having a retainer and a stop at the rear, a pedal over the base frame, having a joint linked with the retainer of the base frame and a free end, two-sided massage pads mounted on the top of the pedal for the user to stamp on, and a drive mechanism designed with a bias wheel, which enable continuous bias operation of the free end of the pedal, thus the free end and linked end of the pedal are moved up and down continuously.

### BRIEF DESCRIPTION OF DRAWINGS

The drawings disclose an illustrative embodiment of the present invention, which serves to exemplify the various advantages and objects hereof, and are as follows:

FIG. 1 shows a complete assembly of an improved obliquely erected muscle exercise walker of the invention.

FIG. 2 shows a disassembly of an improved obliquely erected muscle exercise walker of the invention.

FIG. 3 shows a cross-section of the adjustable supporting shaft of an improved obliquely erected muscle exercise walker of the invention.

FIGS. 4(A), (B), (C) and 6 show a side view the walker working at different angles.

FIG. 5 shows an application of an improved obliquely erected muscle exercise walker of the invention.

### DETAILED DESCRIPTION OF THE PREFERRED EMBODIMENT

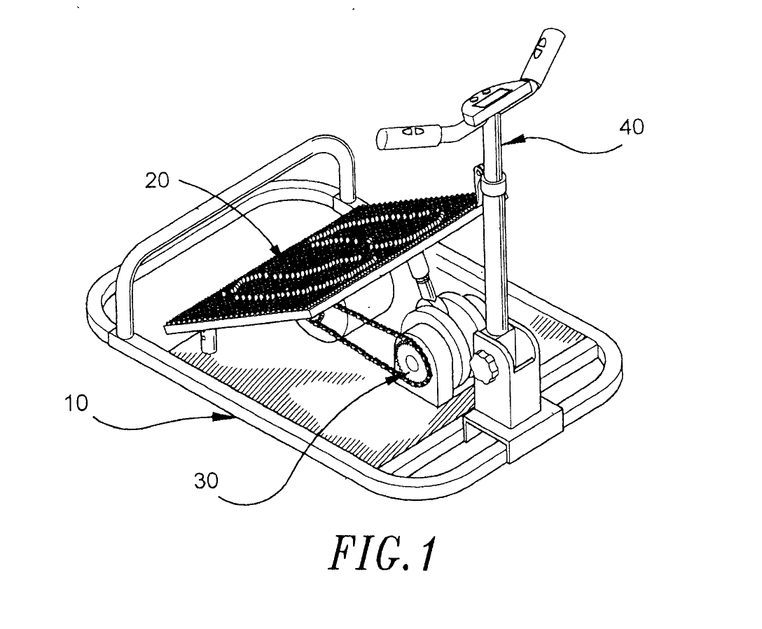

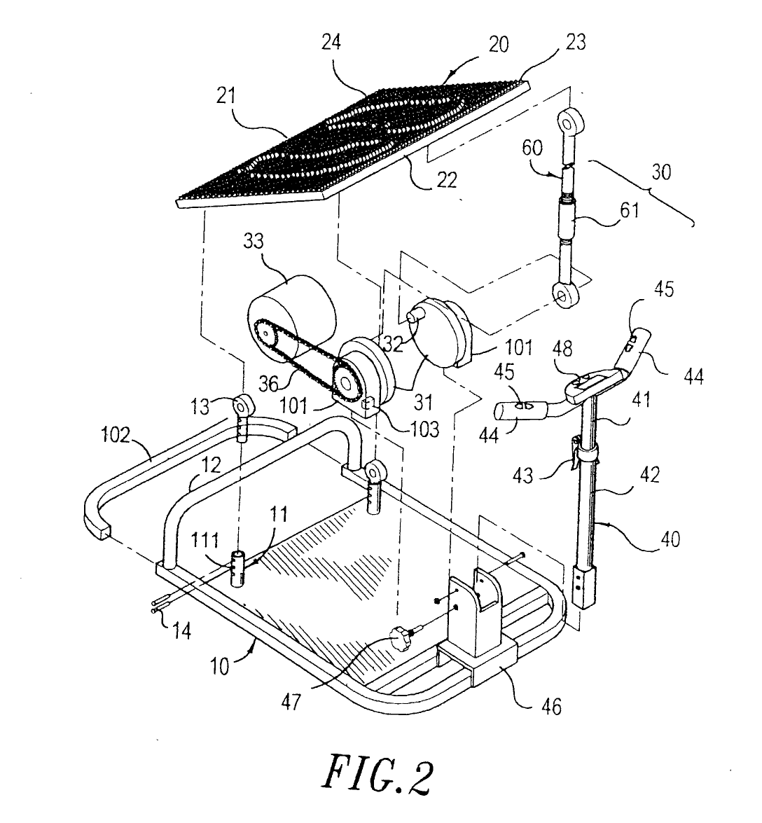

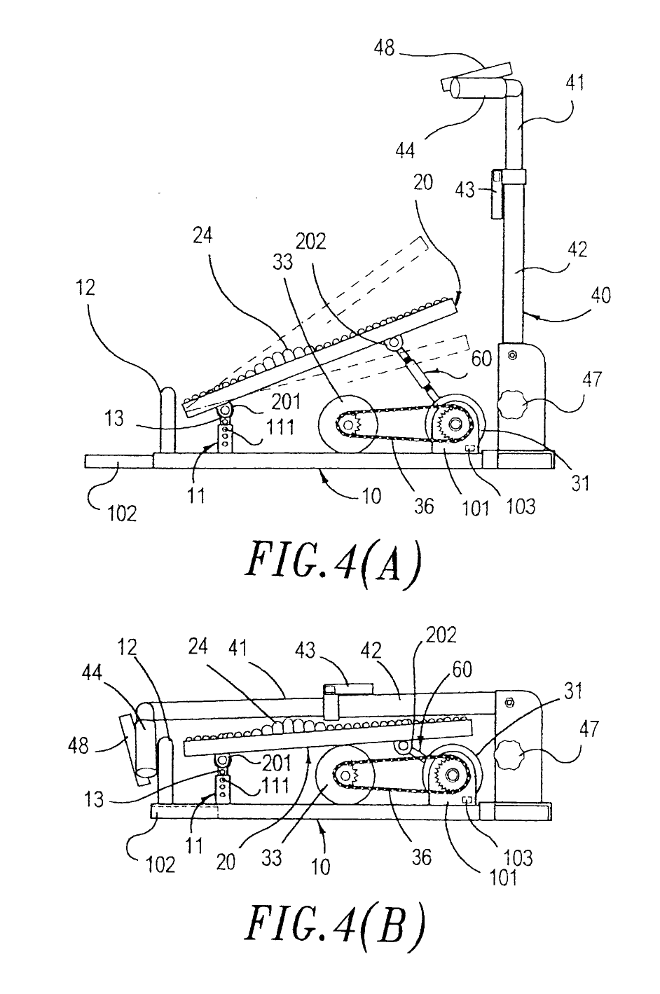

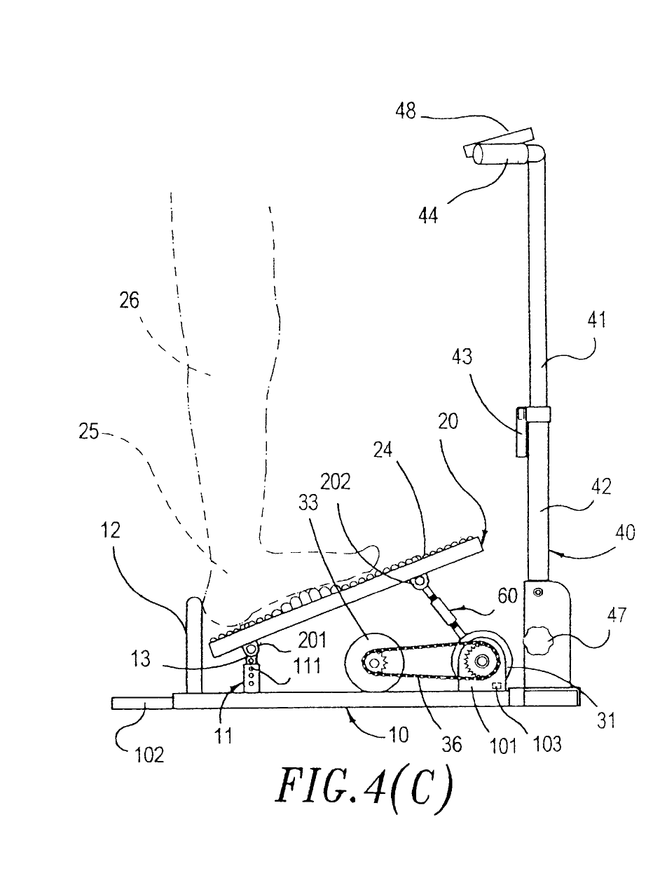

As shown in FIGS. 1 and 2, an improved obliquely erected muscle exercise walker of the invention mainly comprises a base frame 10, a pedal 20 mounted over the base frame 10, a drive mechanism 30 and a handrail 40. The base frame 10 provides a retainer 11 and a stop 12, which is a horizontal bar. The retainer 11 has an adjusting hole 111. The rear end of the base frame 10 has an extension board 102. One end of the pedal 20 is a joint 21 to be linked with the retainer 11; the other end is a free end 22. The base frame 10 and the pedal 20 are united by means of an adjusting shaft 13. The adjusting shaft 13 has one end connected to the lug 201 on the pedal 20 as shown in FIG. 4(A), and the other end of the adjusting shaft 13 is held in the retainer 11 on the base frame 10 and locked by a pin 14 in the adjusting hole 111. The drive mechanism 30 consists of a bias wheel 31 sitting on the bracket 101 of the base frame 10. The bracket 101 is outfitted with a counter 103. The bias wheel 31 makes the bias shaft 32 a bias movement and the counter 103 records the number of bias rotation the bias wheel 31 produces. The drive source 33 is a reduction gear motor with a driving chain 36 to rotate the bias wheel 31. The joint rod 34 has one end locked on the bias shaft 32, and the other free end 35 is linked to the lug 202 of the free end 22 of the pedal 20 as shown in FIG. 4(A). A handrail 40 is uprightly erected in the front of the base frame 10. The handrail 40 extends two handles 44 for the player to hold and keep the body in balance while standing with inclined feet. The handrail 40 permits installation of energy meters 45, such as a clinical thermometer, fat meter or blood pressure meter. The energy meters 45 are interconnected to the display panel 46 to show the actual reading measured.

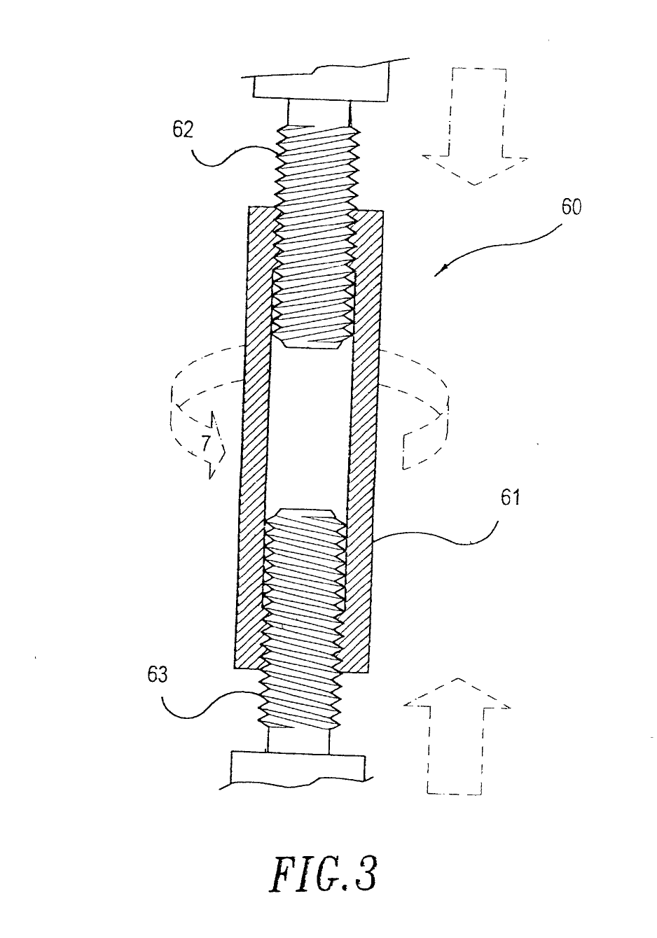

FIG. 3 shows an adjustment design of an support shaft 60, which contains a tube 61 having the counter female thread drilled inside at both ends, and adjusting bolts 62 and 63. When using the right hand to turn the bolt 62 and the left hand to turn the bolt 63 in the direction 7, the length of the support shaft 60 is shortened. It means that the breadth of up and down vibration of the pedal 20 produced by the bias wheel 31 and the drive source 33 will be decreased, or vice versa.

The main purpose of the extension board 102 mounted on the rear end of the base frame 10 extends the area the walker occupies so as to keep the walker always in a stable position without tilting down or slide when the player loses balance. As shown in FIG. 4(B), the extension board 102 can be stored inside the base frame 10 when not in use so as to reduce the space required for storage.

As shown in FIG. 4(C), a massage pad 23 with uneven projected grains 24 is mounted on the top of the pedal 20. When intimately contacted with the sole of the feet, the grains 24 generate a massage effect on the vital points of the sole, which vitalizes the blood circulation.

In addition, the base frame 10 provides an extension catcher 43 permitting the length adjustment for the tube 42 and the extension rod 41 of the handrail 40.

As shown in FIG. 4(C), the retainer 11 keeps the lean-to shank 26 always in a straight posture, in addition to preventing the heel 25 slipping out of the pedal 20. The stop 12 shall be wrapped with a soft pad for protection against injury to the player.

As shown in FIG. 4(B), the base frame 10 provides a lock knob 47 on the yoke 46. When the lock knob 47 is loosened, the whole handrail 40 can be lowered and laid horizontally on the base frame 10.

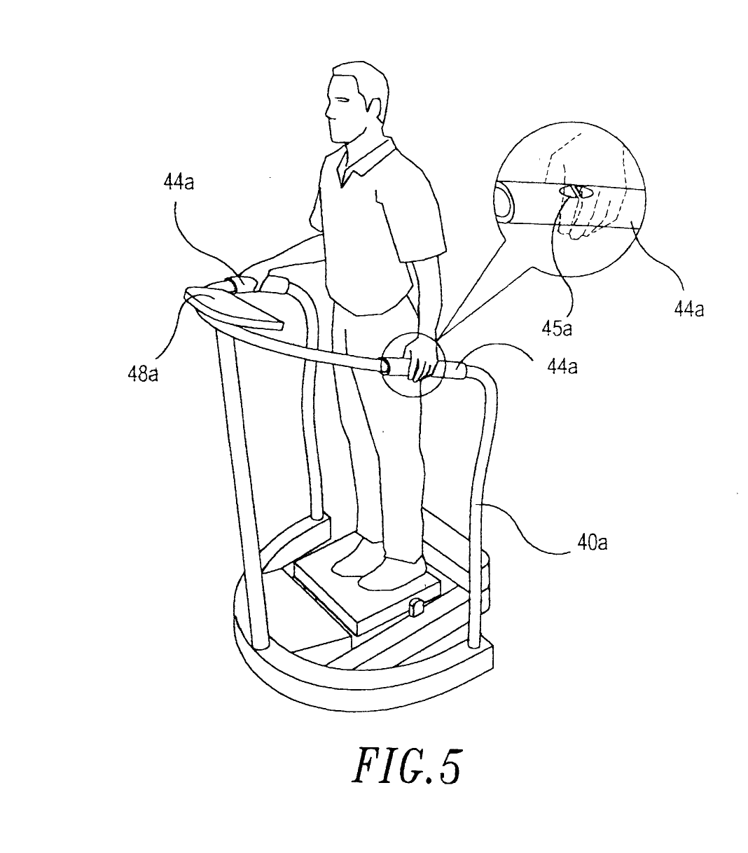

FIG. 5 shows the application of an improved obliquely erected muscle exercise walker. The handrail 40a is in a big-scaled size for installation and use in public arena. The handrail 44a outfits with an energy meter 45a and display panel 48a. This design is beneficial to the promotion of public health.

Comparing with the prior art, the obliquely erected muscle exercise walker demonstrates the following advantages:

1. The player stands on the pedal in a manner with the toes higher than the heel, and the shank of the leg is always kept in the straight posture; by the up and down movement produced by the bias wheel, the muscle of the leg is therefore forced to stretch out, the blood vessels are relaxed and the back bone is straightened up. The inclined standing pose further vitalizes the internal organs, such the kidneys and pelvis.

2. The pedal acts a massage effect on the two soles to enhance blood circulation and to alleviate the pain in the shank as a result of over-exercise.

3. The improved obliquely erected muscle exercise walker of the invention has the features of a simplified structure, light weight, easy portability and storage, suitable for the office workers, computer operators, pilots, drivers, travelers and the survivors from the surgical operation to play in house, car, cabin and outdoors for a physical exercise without space and time limit, and it is also good for the sportsman to take a warm-up prior to the intense practice.

Many changes and modifications in the above-described embodiment of the invention can, of course, be carried out without departing from the scope thereof. Accordingly, to promote the progress in science and the useful art, the invention is disclosed and is intended to be limited only by the scope of the appended claims

What is claimed is:

1. An improved obliquely erected muscle exercise walker, at least comprising:
a base frame having a retainer and a stop, said retainer providing adjusting holes;
a pedal having one end linked to said retainer of said base frame and a free end;
a drive mechanism, mounted on a bracket, said bracket further locked on said base frame, said drive mechanism consisting of at least a bias wheel mounted on said base frame, a bias shaft of said bias wheel making eccentric movement, a power source providing continuous rotation to said bias wheel, a supporting shaft having one end linked to said bias shaft and other end connected to said free end of said pedal; and
a handrail mounted in front of said base frame.

2. The improved obliquely erected muscle exercise walker of claim 1, wherein said base frame and said pedal are united by an adjusting shaft having one end linked to a lug of said pedal and the other end inserted into said adjusting shaft with a selective lock in said adjusting hole.

3. The improved obliquely erected muscle exercise walker of claim 1, wherein said power source is a reduction gear motor driving said bias wheel by a drive chain.

4. The improved obliquely erected muscle exercise walker of claim 1, wherein said base frame connects an extension board.

5. The improved obliquely erected muscle exercise walker of claim 1, wherein a massage pad is mounted on the top of said pedal.

6. The improved obliquely erected muscle exercise walker of claim 5, wherein said pedal provides a convex foot pattern on said massage pad.

7. The improved obliquely erected muscle exercise walker of claim 1, wherein height of said handrail is adjustable.

8. The improved obliquely erected muscle exercise walker of claim 1, wherein said handrail has a display panel and two handles, said handles are outfitted with an energy meter, readings of said energy meter will be displayed on said display panel.

9. The improved obliquely erected muscle exercise walker of claim 8, wherein said energy meter can be a clinical thermometer.

10. The improved obliquely erected muscle exercise walker of claim 8, wherein said energy meter can be a fat meter.

11. The improved obliquely erected muscle exercise walker of claim 8, wherein said energy meter can be a blood pressure meter.

12. The improved obliquely erected muscle exercise walker of claim 1, wherein said stop is wrapped with a soft protection.

13. The improved obliquely erected muscle exercise of claim 1, wherein said handrail is permitted to fold on said base frame.

14. The improved obliquely erected muscle exercise walker of claim 1, wherein said supporting shaft constitutes a tube drilled the reverse female thread at both ends and two adjusting bolts.

15. The improved obliquely erected muscle exercise walker of claim 1, wherein said bias wheel is outfitted with a counter to record numbers of rotation said bias wheel produces.
